(19) United States
(12) Patent Application Publication
(10) Pub. No.: US 2008/0020449 A1
(43) Pub. Date: Jan. 24, 2008

(54) Method For Separating Bast Fibers

(76) Inventors: Hironori Matsubara, Aichi (JP); Kouichi Kondou, Aichi (JP); Junko Sakurai, Aichi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/585,280

(22) PCT Filed: Dec. 28, 2004
(86) PCT No.: PCT/JP04/19622

§ 371 Date: May 24, 2007

(30) Foreign Application Priority Data
Jan. 6, 2004 (JP) 2004-000999
Jun. 14, 2004 (JP) 2004-175452

(51) Int. Cl. D01C 1/02; B27L 11/08; D01C 1/04; D06M 16/00; D21F 13/00

(52) U.S. Cl. 435/263; 162/122

(57) ABSTRACT

A pressing step for pressing a bast is provided prior to a step for immersing the bast in an aqueous solution to decompose a gum existing in the bast and bonding bast fibers to each other. The bast fibers and the gum of the bast are mechanically separated from each other, so that an area of contact of the gum existing in the bast and the aqueous solution is increased, thereby promoting decomposition of the gum.

### TECHNICAL FIELD

The present invention relates to a method for collecting bast fibers existing in bast of a so-called bast plant, such as kenaf or jute.

### BACKGROUND ART

Bast fibers existing in a bast plant have been conventionally used as base materials for interior equipments for vehicles, etc. A stem of such a bast plant is composed of a bast and a core, and the bast is composed of an exodermis and an endodermis. The endodermis is mainly composed of bast fibers and pectin known as a gum or other such materials. This gum serves to bond the bast fibers to each other, and also serves to bond the exodermis and the endodermis to each other. In the prior-art technique, the stem of such a bast plant is separated into the bast and the core, and the bast is immersed in water. As a result, the gum is decomposed by microorganisms in the water, so that the bast fibers are separated from each other, and the exodermis is removed. Thus, the bast fibers are collected. However, in this method, it takes time for the microorganisms in the water to decompose the gum such as pectin.

In view of this, recently, developments has been promoted in order to solve the above described problem. For example, in Patent Document 1 described below, a gum existing in bast is chemically treated in a warm aqueous solution containing an alkali substance and hydrogen peroxide or a hydrogen peroxide generating material, so as to be decomposed. According to this method, the time required for collecting fibers is reduced, so that productivity can be improved.

### Patent Document 1: JP 2003-201689 A

### DISCLOSURE OF THE INVENTION

### PROBLEM TO BE SOLVED BY THE INVENTION

It is an object of the present invention to further reduce the time required for separating bast fibers from each other. That is, the present invention provides a method in which it is possible to reduce the time required for immersing a bast in an aqueous solution in order to separate the bast fibers from each other without adjusting an aqueous solution as in the above-described technique. Further, it is an object of the present invention to provide a method in which it is possible to separate the bast fibers from each other in a reduced time even in a case that chemical treatment is carried out by utilizing the aqueous solution containing some chemicals as described above.

### MEANS FOR SOLVING THE PROBLEM

In order to achieve the above-described object, an embodiment of the present invention is a method for separating bast fibers existing in a bast of a bast plant, which is characterized by comprising a first step for separating the bast plant into the bast and a core, a second step for pressing the bast separated from the core, and a third step for immersing the pressed bast in an aqueous solution in order to decompose a gum existing in the bast and bonding the bast fibers to each other.

According to this method, the bast for the bast fibers is pressed while it is separated from the core, so that pressure can be applied to the bast fibers and the gum such as pectin existing in the bast and bonding the bast fibers to each other, to thereby mechanically partially separate the bast fibers and the gum. This makes it possible to reduce an area of contact of the bast fibers and the gum and to increase an area of the gum that is exposed on the surface of the bast. Thus, it is possible to increase an area of contact of the aqueous solution and the gum in the third step, so it is possible to decompose the gum in a shorter time than in the prior art. As a result, it is possible to reduce the third step.

In the present invention, the “bast plants” refers to plants whose leaves and stems have the bast fibers that can be used as industrial materials for woven fabrics, papers, ropes, knitted goods or other such articles. Examples of bast plants are kenaf, jute, hemp, flax, paper mulberry, paper bush or other such plants. Further, the “bast fibers” are fibers existing in the leaves and stems of the bast plants.

In the present invention, the “aqueous solution” in which the bast is immersed in the third step means an aqueous solution in general containing an element that can decompose the gum. That is, the aqueous solution includes an aqueous solution containing microorganisms that can decompose the gum, and an aqueous solution containing an alkali substance and hydrogen peroxide or chemicals including a hydrogen peroxide generating agent or other such agents. Examples of the microorganisms that can decompose the gum are hemicellulose decomposing bacteria or cellulose decomposing bacteria. These bacteria may be bacteria contained in waters of natural water place such as rivers or lakes, or cultured bacterial.

A preferred embodiment of the present invention is, in the above described method for separating the bast fibers, characterized in that said second step presses the bast in a thickness direction of the bast fibers.

According to this method, in the pressing step, the fibers are prevented from being applied with a force in the length direction thereof. Therefore, the fibers are prevented from being cut off, and the fibers can be subjected to a force so as to be unbound. As a result, the fibers can be maintained as longer fibers so as to be reliably separated from each other or to have a condition in which the fibers can easily separated from each other.

Further, in order to achieve the above-described object, an embodiment of the present invention is, in the above described method for separating the bast fibers, characterized in that said second step is a roller pressing step that is performed by passing the bast between rollers or between a roller and a flat die.

According to this method, at least as compared with a case in which the bast is pressed by upper and lower flat dies, continuous pressing can be easily performed. This may lead to increased productivity.

Next, another preferred embodiment of the present invention is characterized in that a surface of the roller or the flat die is formed with convex-concave portions in order to flaw a surface of the bast in the roller pressing step.

According to this method, in the roller pressing step, the bast can be pressed, and the surface of the bast can be flawed by the covex-concave portions formed in the surface of the roller or the flat die. As a result, the area of gum that is exposed on the surface of the bast can be increased. Thus, it is possible to increase an area of contact of the aqueous solution and the gum in the third step, which allows the gum to decompose in a shorter time than in the prior art. As a result, it is possible to reduce the third step.

Further, another preferred embodiment of the present invention is characterized in that said roller pressing step includes a plurality of rollers that are disposed successively in multiple stages along a direction that said bast is conveyed, and a plurality of rollers or flat dies that are disposed in multiple stages so as to respectively face said respective rollers, in order to roller press said bast by conveying said bast between said respective rollers and the rollers or flat dies, and that distances between respective surfaces of said rollers facing each other or distances between surfaces of the rollers and surfaces of the flat dies reduce from an inlet side toward an outlet side along the conveying direction.

According to this method, it is possible to continuously press the bast a plurality of times corresponding to the number of rollers. Thus, it is possible to apply pressure to the bast more frequently or over a wider range. As a result, the area of gum that is exposed on the surface of the bast can be increased. Further, the distance between the rollers or between the rollers and the flat dies is larger at an inlet side in the conveying direction and is smaller at an outlet side in the conveying direction. Therefore, at least compared with a case in which the distance is fixed to a small distance, a burden on the pressing device can be reduced.

Further, another preferred embodiment of the present invention is characterized by including a fourth step for washing the bast by spraying an aqueous solution against the bast at a high pressure after the third step.

According to this method, a so-called high pressure washing is performed on the bast, so that the exodermis and the gum remaining on the surface of the bast fibers can be washed away and removed with the pressure.

Further, another preferred embodiment of the present invention is characterized in that, in said third step, the bast is immersed in an aqueous solution containing microorganisms that can decompose the gum, the aqueous solution is circulated so as to flow in the bast portion and is aerated, and a solid substance is collected at a position spaced apart from the bast.

According to this method, the aqueous solution can be circulated, so that the microorganisms that can decompose the gum can contact the gum more uniformly and effectively. Further, the aqueous solution is aerated, so that oxygen concentration in the aqueous solution can be prevented from reducing. Also, the solid substance in the aqueous solution is collected at a position spaced apart from the bast fibers, so that the aqueous solution can be prevented from being contaminated. As a result, the microorganisms can be maintained in a highly activated state. Thus, it is possible to reduce the time required for separating the bast fibers.

Here, the “solid substance” in the present specification refers to in-water solid substances in general except for the bast fibers and the alive microorganisms, that is, decomposition products resulting from the decomposition of the gum by the microorganisms, the separated exodermis, carcasses of the microorganisms (feces of the microorganisms) or other such substances.

Another preferred embodiment of the present invention is characterized in that, in said third step, the bast is put in a container formed from a perforated member, and the container is immersed in an aqueous solution containing microorganisms that can decompose the gum so that a part of the container is exposed above a surface of the aqueous solution and is rotated therein.

According to this method, the aqueous solution is circulated by the rotation of the container, so that the microorganisms for decomposing the gum can contact the gum more uniformly and efficiently. Further, due to the centrifugal force generated by the rotation of the container, the solid substance resulting from the decomposition of the gum by the microorganisms is discharged to the exterior of the container, so that the solid substance can be removed from the periphery of the bast fibers or reduced. Further, because a portion of the container is exposed on the surface of the aqueous solution, upon rotation of the container, the aeration can be performed, so that the oxygen concentration can be prevented from reducing. As a result, the microorganisms can be maintained in a highly activated state, so as to reduce the time required for separating the bast fibers.

Further, another preferred embodiment of the present invention is characterized in that the bast is cut in a longitudinal direction prior to the third step.

According to this method, the length of the bast is reduced, so that degree of exposure of the gum can be increased. Also, degree of freedom of movement of the bast can be improved when the bast is immersed in the aqueous solution. Thus, the contact of the gum and the ingredients of the aqueous solution is further activated, so as to reduce the time required for the decomposition of the gum.

### EFFECT OF THE INVENTION

According to the present invention, it is possible to provide a fiber separation method that can remarkably reduce a time required for separating bast fibers from each other. Thus, it is possible to efficiently obtain the bast fibers separated from each other in a short time.

### BRIEF DESCRIPTION OF THE DRAWINGS

FIG. 1 A flowchart of an embodiment of a method for separating bast fibers according to the present invention.

FIG. 2 A sectional view of rollers according to an embodiment of a pressing device that can perform a second step of the present invention.

FIG. 3 A perspective view of a roller of the pressing device of FIG. 2.

FIG. 4 An enlarged view of an embodiment of a surface of a roller main body of the roller of FIG. 3.

FIG. 5 A table showing processing conditions for an embodiment of the present invention and controls.

FIG. 6 A graph showing results in defibration condition of the embodiment of the present invention and the controls after processing.

FIG. 7 A plan view of an embodiment of a defibration device that can perform a letting step in the present invention.

FIG. 8 A schematic view showing a condition in which the bast fibers are defibrated by using the device of FIG. 7.

FIG. 9 A perspective view of another embodiment of the defibration device that can perform the letting step in the present invention.

FIG. 10 A perspective view of a container of the device of FIG. 9.

FIG. 11 A perspective view showing a condition in which the bast fibers are put in a water-permeable bag.

FIG. 12 A schematic view showing a condition in which the bast fibers are defibrated by using the device of FIG. 7.

FIG. 13 Graphs showing a defibration period for obtaining defibrated bast fibers by using various processing methods and fiber strength of the bast fibers obtained.

### BEST MODE FOR CARRYING OUT THE INVENTION

In the following, an embodiment of the present invention will be described.

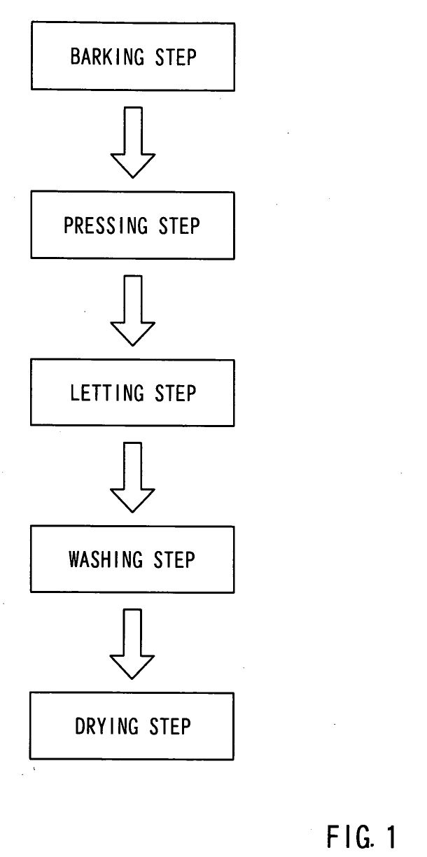

A method for separating bast fibers according to the present invention is conducted based on a flowchart of FIG. 1, and a barking step, a pressing step, a letting step, a washing step and a drying step, which will be hereinafter described in detail, are successively executed. In this embodiment, a method for obtaining kenaf bast fibers will be described, in which kenaf known as a bast plant that grows rapidly is used as a material.

### [Barking Step]

First, the barking step will be described. This step corresponds to a first step of the present invention. The barking step can be conducted manually or by machine. For example, in a manually barking method, a tool is inserted between a core and a bark, and barking is carried out in a direction of fibers in the bark, i.e., a bast. If barking is carried out in a longitudinal direction of a stem, i.e., in a direction that the fibers extend, damage of the bast fibers can be suppressed, so that a required length of the fibers can be maintained. In particular, kenaf which has grown to a diameter of approximately 20 mm and a height of approximately 4000 mm is harvested, and after roots, leaves, distal end portions, etc. thereof is cut off, the bast is separated from the core by manually barking the same, thereby obtaining the bast of approximately 60 mm×3000 mm×1 mm. The bark obtained through the barking step, i.e., the bast, is composed of an endodermis containing a large amount of fibers and an exodermis covering an outer side of the endodermis.

### [Pressing Step]

Next, the bast obtained by said barking step is pressed by a pressing device. This step corresponds to a second step of the present invention. The pressing can be performed in a known pressing method in which the bast can be pressed in a direction perpendicular to the bast fibers, for example, in a thickness direction. For example, the pressing can be performed by utilizing a pair of dies having flattened abutting surfaces, in which the bast is placed on the lower die, and the upper die is pressed toward the lower die at a predetermined pressure. Alternatively, the bast may be placed on a flat die, and a roller may be rolled thereon while applying the roller with a predetermined pressure. Due to pressure that is applied in a direction perpendicular to the bast fibers, i.e., in a thickness direction, it is possible to mechanically destroy mutual bonding of the bast fibers and bonding between the bast fibers and the exodermis, which bonding is formed via a gum. Further, due to such a pressure, it is possible to squeeze out water and bonding ingredients such as the fluidizing gum. In the bast obtained by the pressing, the exodermis is separated or is in an easily separable condition, so that the bast fibers are exposed or are in an easily exposable condition. Further, the mutual bonding of the bast fibers or other such bonding is destroyed, so that the bast fibers are in a separated condition or are in a separable condition. This results in increase of the surface area of the bast, in particular, the surface area of the gum. This further results in increase of a proportion of the bast fibers that is in the easily exposable condition, and the gum that bonds the bast fibers together.

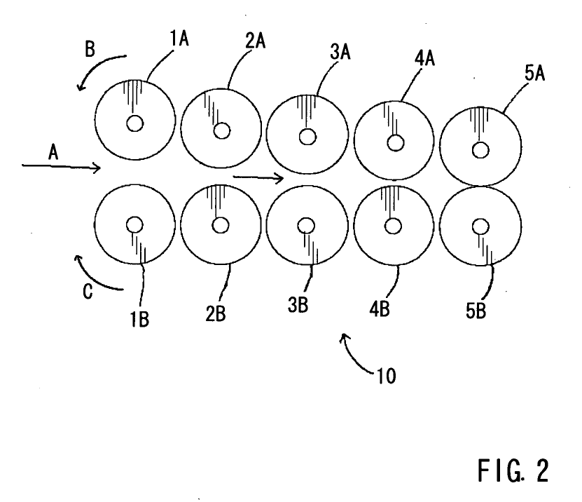

In the following, a pressing device used in this embodiment will be described in detail with reference to FIGS. 2 to 4. FIG. 2 is a sectional view of the rollers of the pressing device 10 used in this embodiment. In the pressing device 10, a plurality of pairs of rollers, five pairs of rollers in this embodiment, that face each other are provided successively. As shown in the drawings, five horizontally arranged lower rollers 1B to 5B and five upper rollers 1A to 5A are provided. The upper rollers 1A to 5A respectively situated directly above the corresponding lower rollers 1B to 5B so as to face the same. Here, charging of the bast into the pressing device is carried out by charging the bast between the upper and lower rollers in a direction shown by an arrow A of FIG. 2. Thus, in the following, the roller 1A, 1B side will be referred to as an inlet side, and the roller 1A to 5A side will be referred to as an outlet side.

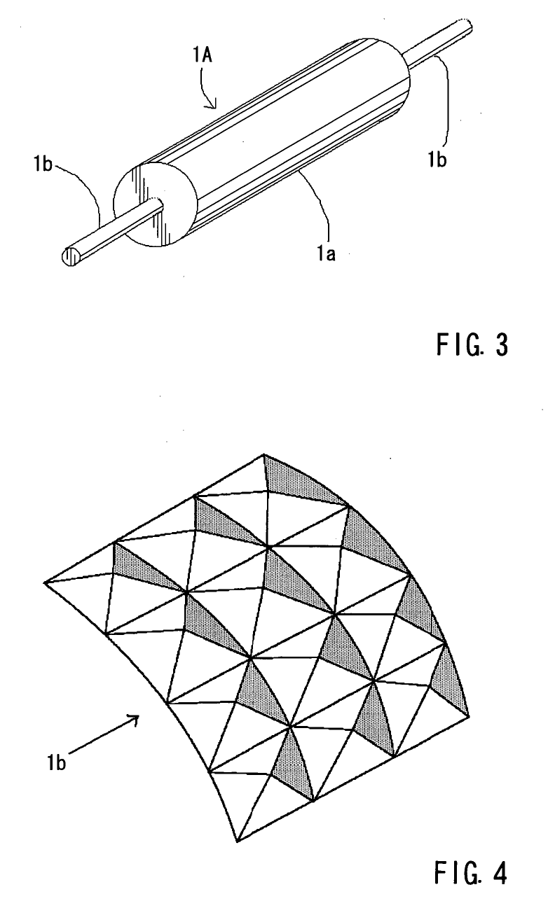

All of the upper and lower rollers 1A to 5A and 1B to 5B have the same shape and the same size. In the following, the upper roller 1A that is one of those rollers will be described. The upper roller 1A is formed of stainless steel in order to prevent rusting thereof, and has a cylindrical roller main body 1a having a diameter of approximately 40 mm and a length of approximately 300 mm. Also, the upper roller 1A has support portions 1b that are positioned at both ends in a direction perpendicular to a rotating direction of the roller main body 1a (width direction). The support portions 1b extend from the ends of the roller main body 1a over approximately 100 mm and having a diameter of approximately 20 mm (see FIG. 3). Further, pyramid-shaped convex-concave portions are regularly formed on a surface of the roller main body 1a. Each convex-concave portions has a side of approximately 1 mm at a base thereof and a height of approximately 0.1 mm (see FIG. 4).

Further, in the pressing device 10, the distance between the upper and lower rollers gradually reduces from the inlet side toward the outlet side. For example, the distance between the upper roller 1A and the lower roller 1B that are arranged on the inlet side (distance between the surfaces of the rollers) is 0.8 mm, the distance between the upper roller 2A and the lower roller 2B arranged adjacent thereto is 0.6 mm, the distance between the upper roller 3A and the lower roller 3B is 0.4 mm, the distance between the upper roller 4A and the lower roller 4B is 0.2 mm, and the distance between the upper roller 5A and the lower roller 5B arranged on the outlet side is 0.0 mm. Further, the distance between the adjacent rollers is approximately 20 mm. Further, the distance between the rollers described therein is the distance between apexes of the pyramid-shape protrusions provided on the surface of the roller main body 1a.

The lower rollers 1B to 5B and the upper rollers 1A to 5A constructed as described above are rotatably secured via the support portions 1b positioned at their ends. The support portions 1b are connected to a motor (not shown) via a belt or other such elements. During operation of the pressing device 10, upon rotation of the motor, the rollers are rotated at a desired rotating speed at their respective fixed positions while the support portions are not moved.

In the following, a method for pressing the bast obtained from the above-described barking step by using the pressing device as described above will be illustrated. The bast is fed between the upper and lower rollers in the direction shown by an arrow A of FIG. 2 while the bast is directed such that the thickness direction thereof is perpendicular to a width direction of the rollers. In this process, the rollers are rotated in directions shown by arrows B and C at a speed of 15 to 20 rpm. All of the rollers are rotated at the same speed. As a result, the bast charged into the pressing device is squeezed and pressed by the rollers. At the same time, the bast is conveyed from the inlet side toward the outlet side by the rotational force of the rollers.

Thus, it is possible to press the bast fibers and the gum such as pectin that exist in the bast along the thickness direction thereof. As a result, it is possible to mechanically separate the bast fibers and the gum that exist in the bast. This makes it possible to reduce the area of contact of the bast fibers and the gum as well as increase the area of the gum that is exposed on the surface of the bast. Because the surface of the roller main body 1a is formed with the convex-concave portions, the surface of the bast can be easily flawed. Therefore, the exodermis can be reliably removed, so that the area of gum that is exposed on the surface of the bast can be increased. Further, because the pressing can be successively performed in the thickness direction of the bast fibers, the pressing treatment can be efficiently performed. In particular, by using a plurality of rollers, because the same portion can be pressed repeatedly many times, frequency of the pressing can be increased in a shorter time.

Further, in the pressing step using the pressing device 10, the distance between the upper and lower rollers facing each other are gradually reduced from the inlet side toward the outlet side. Therefore, it is possible to repeatedly press the bast while gradually reducing the thickness thereof, thereby to mechanically separate the bast fibers and the gum from each other. If the bast having a large thickness is directly pressed between the rollers that are spaced apart from each other by a small distance, a load applied on the pressing device is increased. This may lead to an increased possibility of device failure. Also, a load applied on the bast fibers existing in the bast is increased. This may lead to an increased risk of break out of the bast fibers.

The bast that is subjected to the barking step contains a portion called a knot (a base portion of a branch that is removed when kenaf is harvested) which is harder and thicker than the other portions. Thus, another problem with conventional techniques is that if a letting step (which will be described hereinafter) is directly carried out after the barking step described above is completed, the decomposition of the gum existing in the knot portion does not easily proceed. However, due to the pressing step, the knot portion is crushed. Therefore, even at the knot portion, it is possible to reduce a decomposition time of the gum existing in the letting step. That is, even at the knot portion, it is possible to increase the area of gum that is exposed on the surface of the bas by mechanical separation. Thus, for example, even if the letting step or a chemical immersion step is performed at the same degree as the other portions, it is possible to separate the fibers at knot portion so as to have the same quality as the fibers of the other portions.

### [Letting Step]

Next, the letting step corresponding to an embodiment of a third step of the present invention will be described. In this step, the bast that was processed in the pressing step described above is immersed in waters existing in nature, such as pond water, and is left at normal temperature for approximately ten days. In this letting step, microorganisms that can decompose the gum are propagated at a contact portion of the gum and an aqueous solution, and the microorganisms decompose the gum. Thus, it is desirable that the area of contact of the gum and the aqueous solution is large. In the present invention, because the surface area of the gum that is exposed on the surface of the bast is enlarged by the pressing step described above, it is possible to reduce the time required for decomposing the gum.

### [Washing Step]

Next, the bast (fibers) that was subjected to the letting step is washed. This washing step corresponds to a fourth step in the present invention. In the washing step, for example, Device K370 Plus manufactured by Karcher Japan is used in order to perform washing, in which an aqueous solution is sprayed against the bast (fibers) at a high pressure of 7 to 8 kgf/cm² at a rate of 15 seconds/m² while both end portions of the bast is fixed in place. This method that is referred to as high pressure washing is a known technique that is used for washing vegetables, etc. When this method is applied to the bast that is subjected to the pressing step, the bast (fibers) can be washed, and the exodermis and the gum remaining on the surface of the bast fibers can also be removed with the pressure. In the washing step, the high pressure means a pressure of 7 MPa or more. Further, the aqueous solution that can be used in the washing step is not limited to any special solutions. It is possible to use water containing various metal ions, etc. and a chlorine-based germicide or other such substances, for example, tap water. Further, the aqueous solution may contain a solid substance insofar as no clogging occurs in an ejection nozzle or an intake pump of a high pressure spraying device.

### [Drying Step]

Further, the bast that was processed in the washing step is air-dried in the open air for three days. The bast thus obtained contains little gum. That is, the bast contains almost no ingredient for bonding the fibers to each other. Therefore, the bast that was subjected to the drying step can be easily separated through manual operation.

### [Evaluation]

The bast that was obtained after these steps describe above was evaluated in terms of stripping of exodermis (%) and separating of bast fibers (%). The result showed that the stripping of exodermis was 100% and the separating of bast fibers was 95%. The evaluation standards for “the stripping of exodermis” and “the separating of bast” were as follows.

The stripping of exodermis (%): This item was evaluated in the bast after the completion of the drying step via visual observation as to what percent in sectional area ratio (area ratio of the cut end surface of the bast) of the exodermis that had been totally bonded to the bast fibers by the gum was stripped

The separating of bast fibers (%): This item was evaluated in the bast fibers after the completion of the processing via visual observation as to what percent of the bast fibers that had been integrally bound was unbound and separated.

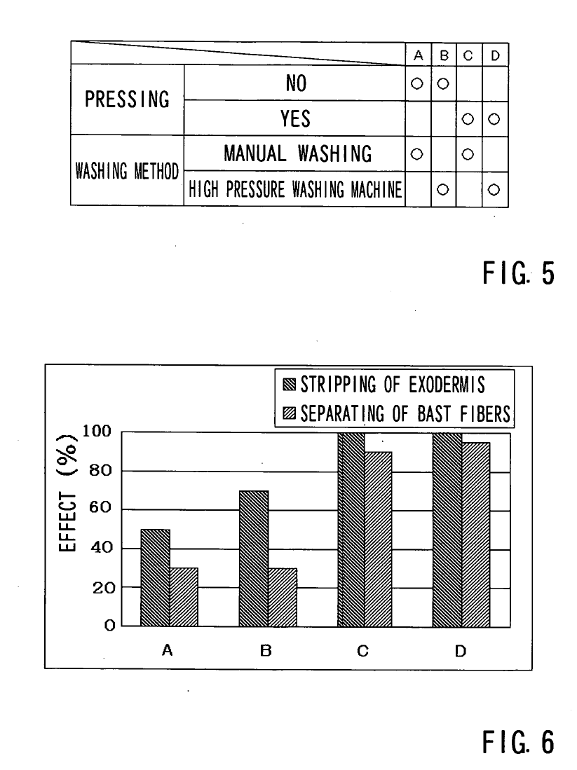

As controls, bast fibers were separated under the conditions A to C of FIG. 5, and evaluation was made in the same manner. The condition A is identical to the condition of the embodiment described above except that the pressing step of the bast is omitted and that the washing step was carried out by manual washing without using a high pressure washing machine. The condition B is identical to the condition of the embodiment described above except that the pressing step of the bast was omitted. The condition C is identical to the condition of the embodiment described above except that the washing step was carried out by the manual washing without using a high pressure washing machine. A condition D corresponds to the condition of the above-described embodiment. Evaluation results are shown graphically in FIG. 6.

It can be seen from graphs of FIG. 6 that unlike evaluation results A and B that correspond to the cases in which the pressing step was omitted, evaluation results C and D that correspond to the cases in which the pressing step was used have a high separation effect. Conversely, the evaluation results B and D that correspond to the cases in which the washing was performed by using the high pressure washing machine have a higher separation effect than the evaluation results A and C that correspond to the cases in which the washing was performed by the manual washing. The evaluation result D that corresponds to this embodiment, in which the pressing step was used and in which the washing was performed by using the high pressure washing machine, has the highest separation effect.

Here, in all of the examples A to D, the letting step was continued over a desired term, which term corresponds to a term in which when in example D, a small amount of bast fibers are removed from the bast immersed in a letting vessel over this term and washed, the surface layer is stripped and the fibers are separated and such a condition can still be retained after drying. As a result, it was found out that in examples A to C, both the stripping of exodermis and the separating of fibers are insufficient, and that in the D, the defibration due to the letting is completed most quickly. In the example D, letting period required for completing satisfactory defibration was seven days. However, with regard to the kenaf bast similar to the B in which the bast pressing step was omitted, the letting period required for leading the satisfactory defibration state was ten days. As a result, it was found that the pressing step may drastically reduce the time required for the defibration of the bast.

In order to evaluate the effect of the high pressure washing, regarding the bast fibers A that were manually washed without performing the pressing step and the bast fibers B that were washed under high pressure without performing the pressing step, yields were calculated by the following formula. Portions (unnecessary portions) other than the fibers such as the surface layer (exodermis) were taken from the whole in order to determine the yield from the following formula : (total weight−weight of unnecessary portions)/total weight×100. As a result, in the example A, the yield was 85%, and in the example B, the yield was 95%. In the bast fibers of example C that was subjected to the pressing step and manually washed, the yield was 95%. From these results, as shown by comparison of the examples A and B, it has been demonstrated that the yield of the bast fibers is improved by the high pressure washing step. Further, as shown by comparison of the examples A and C, it has been demonstrated that the yield of the bast fibers is improved by the pressing step.

### OTHER EMBODIMENTS

An embodiment of the present invention has been described. However, the present invention is not limited to this embodiment and allows for various embodiments without departing from the scope defined in the claims. Other embodiments of the present invention will be described below.

In the present invention, although the barking step is performed manually, it may be performed using a machine. For example, the machine as disclosed in Japanese Patent Application No. 2003-369403 may be used. In this device, a bast plant in which a bast and a core are not separated is fed between two rollers, so that the core is crushed, thereby separating the bast and the core from each other to some degree. After that, the bast is conveyed by a belt conveyor, so that fragments of the core adhering to the bast is removed therefrom by vibration of the conveyer.

Next, in the pressing step of the present invention, the bast is pressed by a plurality of rollers so as to increase a productivity. However, the pressing step is not limited to this method. The bast can be squeezed between flat dies. Also, the pressing can be performed by utilizing a combination of a roller and a flat die.

Further, in the letting step of the present invention, the bast is left at normal temperature in pond or the like existing in nature. However, in order to reduce the time required for the letting step, it is possible to add an appropriate chemical in an artificially provided vessel or to chemically decompose the gum. Further, instead of the letting step, the third step may be changed to a step in which the bast is immersed in a vessel containing a so-called chemical liquid, such as a mixed aqueous solution that contains an alkali substance and hydrogen peroxide or a hydrogen peroxide generating material.

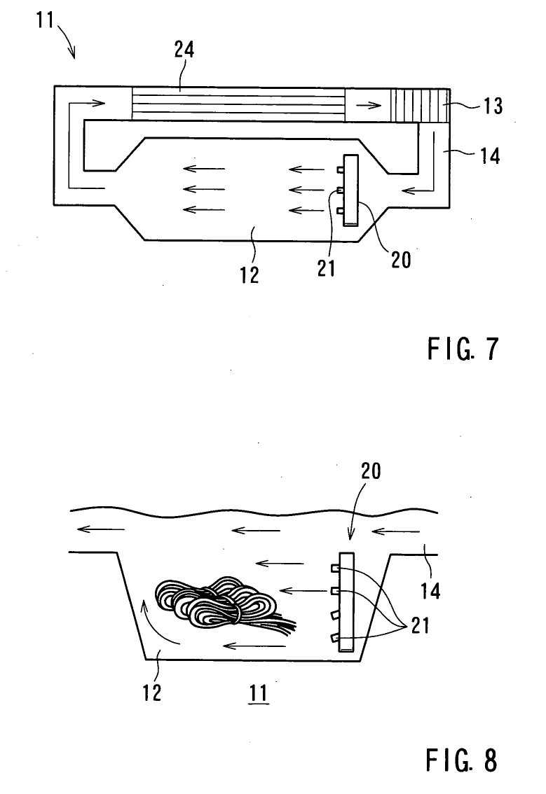

Next, a defibration device that can perform the letting step for the third step and a method for defibrating the bast fibers using this defibration device will be described. FIGS. 7 and 8 show the defibration device 11. As shown in FIG. 7, the defibration device 11 has a processing vessel 12 and a circulating portion 14. The processing vessel 12 is a vessel having a large inner space into which the bast is put. The circulating portion 14 is a circulation path of which the both ends are connected to both end (i.e. opposing surfaces) of the processing vessel 12. In the defibration device 11, the processing vessel 12 and the circulating portion 14 form one circulation flow passage. This circulation flow passage is provided with a flow means 20, an aerating means 13 and a collecting means 24.

The flow means 20 has a known construction that can flow the aqueous solution at a portion in which the bast is immersed. The flow means 20 may be positioned at the circulating portion 14. Preferably, it is positioned at the processing vessel 12 as in this embodiment. In this case, it is possible to reliably flow the aqueous solution of the bast portion. The flow means 20 of this embodiment includes a water pressure imparting means such as a pump (not shown), and a plurality of ejection nozzles 21 shown in FIGS. 7 and 8. In the flow means 20, the water pressure imparting means provides a predetermined pressure to the aqueous solution, so that the ejection nozzles 21 ejects the solution into the processing vessel 12, to thereby flow the aqueous solution. The plurality of ejection nozzles 21 are arranged so as to eject the aqueous solution in the circulating direction of the circulation flow passage. In FIG. 7, as indicated by the arrows, the aqueous solution circulates clockwise within the circulation flow passage that is formed by the processing vessel 12 and the circulating portion 14.

As shown in FIG. 8, the flow means 20 preferably form a flow toward or along a bottom of the processing vessel 12. This may prevent the processing vessel 12 from producing precipitation therein, so that the aqueous solution, in particular, the aqueous solution of the bast portion can be maintained in a cleaner state.

The aerating means 13 has a known construction that can supply oxygen to the defibration liquid contained in the processing vessel 12. For example, it may be a fountain pump, a waterwheel, an air stone or other various types of aerators having an air diffuser pipe. The aerating means 13 may be positioned anywhere in the circulation flow passage. Preferably, in order to avoid a reduction in a contact ratio of the bast and the aqueous solution due to air, it is positioned at a portion in which the bast is not immersed. In this embodiment, it is positioned at the circulating portion 4. As shown in FIG. 7, in the defibration device 11, it is positioned upstream of the flow means 20, i.e., upstream of the processing vessel 12, so that the aqueous solution can be aerated immediately before contacting the bast, to thereby increase oxygen concentration thereof.

The collecting means 24 has a known construction that can collect a solid substance from the aqueous solution and typically includes a filtering portion. As shown in FIG. 7, the collecting means 24 of this embodiment is positioned at the middle portion of the circulating portion 14 so as to cut off the flow passage as a whole. In the collecting means 24, although not shown in particular, in order to be filtrated utilizing gravitation, a filter may be installed horizontally. A partition or the like may be positioned downstream of the filter so as to intercept from the water surface to a predetermined depth. According to this arrangement, the aqueous solution passing through the circulating portion 14 flows into the portion below the partition through the filter. Therefore, a solid substance in the aqueous solution can be reliably collected.

Here, the aqueous solution stored in the circulation flow passage of the defibration device 11 is typically an aqueous liquid that contains microorganisms that can decompose the substance existing between the fibers or between the fibers and the exodermis. The kind of microorganisms contained in the aqueous solution is not limited to any special microorganisms. However, they are, for example, at least one of hemicellulose decomposing bacteria that can decompose hemicellulose such as xylan, and cellulose decomposing bacteria that can decompose cellulose. Hemicellulose decomposing bacteria are preferably contained. The cellulose decomposing bacteria and the hemicellulose decomposing bacteria are obtained by culturing, under a predetermined selective condition, for example, microorganisms contained in soil that abundantly contains microorganism, e.g., soil of a river bed or in woods. The concentration of the microorganisms in the aqueous solution is not limited to any special values. Further, it is to be assumed that the concentration can be fluctuated during defibration or repeated defibration. For example, the concentration is preferably controlled so as to be 1 to 20% by volume. When the aqueous solution, for example, has a pH of 6.5 to 7.0 and a temperature of 30 to 35° C., the microorganisms can be maintained in a satisfactorily activated state.

A method for separating the bast fibers by means of the defibration device 11 will be described. In the device 11, for example, as shown in FIG. 8, it is desirable to bind the bast fibers in a predetermined amount of increments before the bast fibers are fed into the processing vessel 12, in order to avoid entangling of the defibrated fibers. As shown in FIG. 8, the bast is introduced into the processing vessel 2, so as to be immersed in the aqueous solution. Although not shown, if necessary, a metal gauze or the like may be disposed thereon in order to prevent rise of the bast, so that the immersing condition can be stabilized.

Next, the aqueous solution is flowed by the flow means 20 while supplying oxygen by the aerating means 13, so that the aqueous solution is circulated for a predetermined period of time. The flow rate of the aqueous solution caused by the flow means 20 is not limited to any special values. However, if the flow rate is too high, there is a fear that the efficiency of the defibration is reduced. Thus, it is desirable that the flow rate is slow, for example, it is controlled such that the surface of the solution is rippled. Thus, the fibers that have been bonded together by the gum are separated from each other, or the fibers are separated from the exodermis. The period of the immersing under the flowable state is not limited. Generally speaking, it is continued until the fibers can be separated from each other upon light rubbing. Thereafter, the bast is drawn and is washed in water by a washing step similar to the washing step described above or other such step, thereby producing defibrated bast fibers.

In the letting step using the defibration device 11, the microorganisms in the aqueous solution is flowing, so as to contact the bast one after another, thereby to decompose the gum. The solid substance produced by decomposition is released from the bast due to the flowing of the aqueous solution, and the microorganisms quickly contact the newly exposed gum. The separated solid substance is collected by the collecting means 24 shown in FIG. 7, and is removed from the circulating aqueous solution. Further, in this defibration device 11, oxygen is fed into the aqueous solution by the aerating means 13. Therefore, the aqueous solution can be maintained such that the microorganisms for decomposing the gum have a highly activated state. As a result, it is possible to satisfactorily promote the separation of the bast fibers in the bast. Further, the aeration may restrict generation of anaerobic bacteria, so as to satisfactorily suppress generation of bad odor.

Further, the defibration device 11 may reduce the amount of water required for defibration. Since the solid substance is collected by the collecting means 24, a desirable quality of water can be maintained for a long period of time. At the same time, the aeration by the aerating means 13 can prevent generation of the bad odor and can maintain a desired oxygen concentration. As a result, it is possible to use the same aqueous solution for a longer period of time. Therefore, the aqueous solution is less contaminated, so that the burden on the environment at the time of disposal is small.

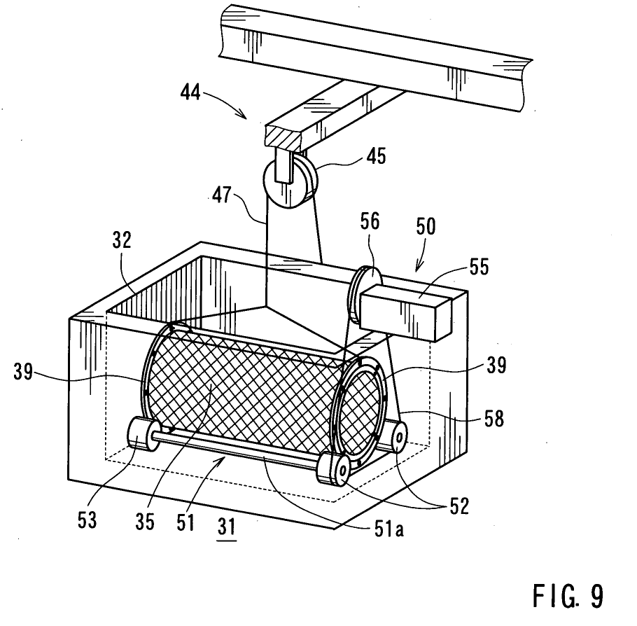

Next, a defibration device 31 according to a second embodiment of the present invention will be described with reference to FIGS. 9 to 12. The defibration device 31 includes a processing vessel 32 and a container 35. Further, the defibration device 31 has a loading/unloading means 44 for loading and unloading the processing vessel 32 with the container 35, and a rotation drive means 50 for rotating the container 35 within the processing vessel 32. In this embodiment, the processing vessel 32 has a rectangular parallel piped-shaped space that can store the defibration liquid and is constructed as a water bath having an upper opening.

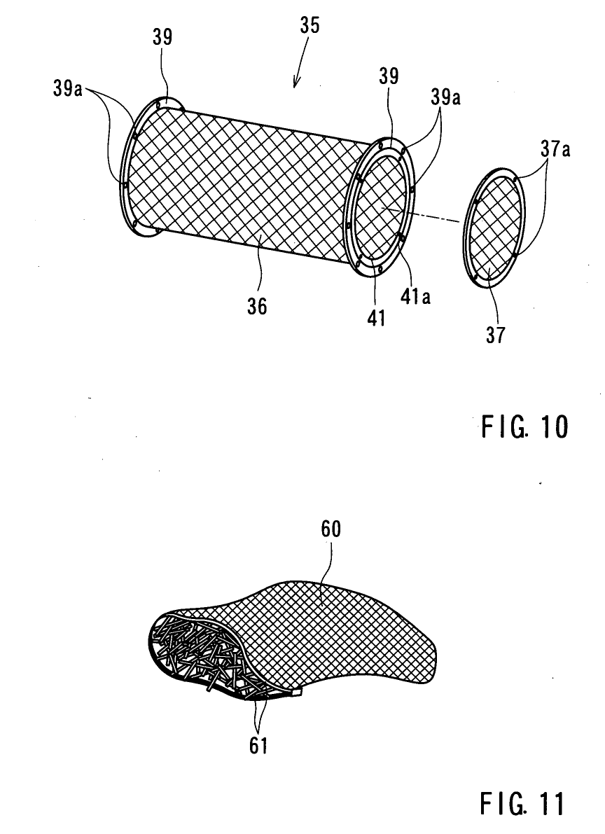

The container 35 is a container formed from a perforated member and has a space that can receive the bast therein. The container 35 can be formed in various configurations and sizes that can be rotatably received within the processing vessel 32. As shown in FIG. 10, in this embodiment, it contains a main body 36 having a bottomed cylindrical shape, and a cover 37 that can close the opening of the main body 36. The main body 36 has annular flanges 39 that are positioned at both ends of a cylindrical portion. The flanges 39 are formed with through-holes 39a for connecting to the loading/unloading means 44, which will be described hereinafter. Further, an inner flange 41 is formed along the inner periphery of the opening of the main body 36, and a plurality of connection holes 41a are formed in the inner flange 41. The cover 37 is formed so as to have an outer peripheral diameter that corresponds to the inner flange 41, and has connection holes 37a that are positioned so as to correspond to the connection holes 41a of the inner flange 41. The cover 37 is fixed to the main body 36 via screws that are passed through the connection holes 37a and 41a of the main body 36 and the cover 37. The perforated member forming the container 35 may be formed of, for example, a plate material having a plurality of through-holes, such as a punching metal, or a net-like material, such as a metal gauze. Also, the perforated member may be made of a flexible material, such as a water-permeable cloth material, such as a knit fabric or a woven fabric.

The bast may preferably be put in the container 35 while it is divided into a plurality of parts by perforated partitions, so as to avoid entangling of the fibers during rotation of the container 35. The partitions may be fixedly provided in the container 35. As shown in FIG. 11, in this embodiment, the partitions are formed as bags 60 that are made of water-permeable net. Because the bags 60 are preferably formed separately from the container 35, the bast can freely move within the container 35 together with the bags 60, so that a burden such as centrifugal force and gravitation can be effectively transmitted to the bast. Each of the bags 60 is provided with a openable and closable slide fastener 61 at its opening, so that the bast can be loaded and unloaded therethrough.

The loading/unloading means 44 may have various known structures that permit to load and unload the processing vessel 32 with the container 35. As shown in FIG. 9, in this embodiment, it has a fixed pulley 45 positioned above the processing vessel 32, a chain 47 and a chain driving machine (not shown). The chain 47 is installed so as to pass the fixed pulley 45 and is connected to the chain driving machine at one end thereof. The other end of the chain 47 is bifurcated in order to have two distal ends, each of which is provided with a hook (not shown). The hook can engage the through-holes 39a formed in the flanges 39 of the container 35. The chain driving machine may have a known construction that can take up or rewound the chain.

The rotation drive means 50 may have a known construction that can rotate the container 35 within the processing vessel 32. For example, it may be constructed from a gear and a motor. As shown in FIG. 9, in this embodiment, it has two sprockets 51 and a motor 55 for rotating the sprockets 51. The sprockets 51 respectively include shafts 51 a that extend in parallel to each other along the lower portion of the processing vessel 32, and rollers 52 and 53 that are attached to both ends of each of the shafts and having flange retainers. The rollers 52 and 53 of each of the two sprockets 51 are arranged so as to engage the flanges 39 of the container 35. The motor 55 is mounted on the upper surface of the processing vessel 32, and has a drive roller 56 that can rotate when the motor 55 is driven. The drive roller 56 is connected to the one roller 52 of each of the sprockets 51 via an endless chain belt 58.

When the defibration device 31 is used, the bast may preferably be previously cut so as to be shortened. The shortened bast may have an increased degree of freedom in the aqueous solution, so that the time required for decomposing the gum can be reduced. The length of the bast is not limited to any special length. The bast may preferably be cut short such that the bast fibers to be obtained may have a length not less than a required length.

To operate the defibration device 31, first, the bast is put into the bags 60 shown in FIG. 11 and the bags are closed. Then, the bags 60 are fed into the container 35 by an appropriate amount, so as to have a filling ratio of, for example, 90% or less. Thereafter, the cover 37 is attached to the container so as to close the same. After that, the container 35 is connected to the chain 47 of the loading/unloading means 44 via the flanges 39 and is then lifted by the loading/unloading means 44, so as to be lowered into the processing vessel 32. At this time, the container is disposed such that the flanges 39 engage the rollers 52 and 53 of the rotation drive means 50. After that, the chain 47 of the loading/unloading means 44 is disengaged from the flanges 39 of the container 35. Here, the amount of the aqueous solution in the processing vessel 32 is controlled so as to have a depth that can immerse at least half the container 35. The container 35 can be completely immersed in the aqueous solution. However, the container may preferably be immersed eighty percent thereof as measured in the height direction. The proportion of the amount of water with respect to the volume of the container may preferably be 60 to 90 percent.

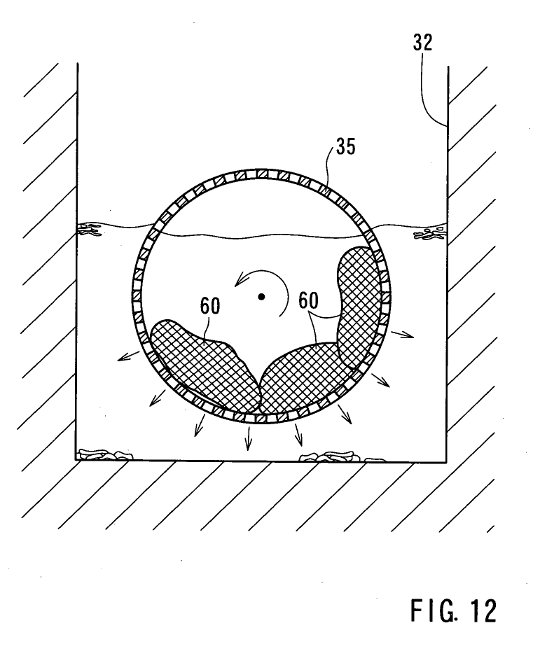

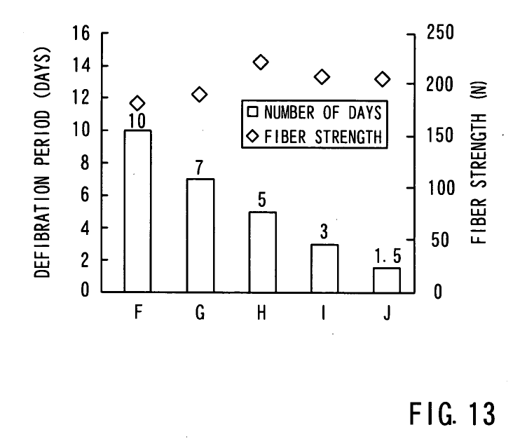

Next, the rotation drive means 50 is actuated to rotate the container 35 within the processing vessel 32. FIG. 12 shows how the container 35 is rotated. The rotation amount in a defibration processing is not limited to any special values. However, if the rotation is too fast, there is a fear that the amount of the liquid within the container 35 is reduced by the centrifugal force, thereby leading an insufficient contact between the vegetation material and the defibration liquid. Further, there is a result that the defibration efficiency is reduced in a rapid river stream, although its mechanism has not been clarified. Therefore, a gentle rotation, for example, a rotation of 12 rpm/min is preferable.

When the letting step is completed, the rotation drive means 50 is stopped, and the container 35 is lifted up from the processing vessel 32 by using the loading/unloading means 44. The bast is drawn from the container 35 or further drawn from the bags 60. The drawn bast is subjected to a washing processing utilizing the above-described high pressure washing or the like and a drying processing, thereby to obtain the defibrated bast fibers. Alternatively, the lifted container 35 is put in a washing vessel or the like, and the bast is then drawn from the container 35 and the bags 60 after it is washed. Thereafter, it is subjected to a drying processing and the like, thereby to obtain the defibrated bast fibers.

In the defibration device 31, the container 35 containing the bast is rotated within the processing vessel 32. As a result, the aqueous solution of the bast portion is flowed, so that a solid substance can be discharged to the exterior of the container 35. That is, upon rotation of the container 35, and upon movement of the bags 60, i.e., the bast, a flow such as convection can be generated in the aqueous solution. Due to the flow of the aqueous solution, many microorganisms may easily contact the bast, and the solid substance is easily separated from the bast. In particular, the solid substance is discharged to the exterior of the container 35 by the centrifugal force, so as to be easily separated from the bast. Further, as shown in FIG. 12, when the depth of the aqueous solution is controlled such that the upper portion of the container 35 is exposed, the aqueous solution and air are mixed together when the container 35 rotates, to thereby cause substantial aeration. Therefore, it is possible to prevent reduction of oxygen concentration in the aqueous solution without providing any aerating means. Further, because the bast itself can move due to the rotation of the container 35, the defibration can be promoted based on a physical impact. Thus, in spite of a simple construction, a flow is produced in the immersed portion of the vegetation material while the defibration liquid is aerated, so that the defibration can be performed with high efficiency.

The solid substance discharged from the interior of the container 35 due to the centrifugal force of the container 35 is mainly precipitated on the bottom of the processing vessel 32. Thus, the solid substance can be collected to a predetermined position without providing any substantial collecting means. The precipitated solid substance can be removed from the bottom of the processing vessel 32 by drawing or the like after the defibration is completed or at an appropriate time. A solid substance having a specific gravity smaller than the aqueous solution may be automatically collected on the liquid surface along the walls of the processing vessel 32. Therefore, such a solid substance can be removed by, for example, scooping up, at an appropriate time. As a result, it possible to separate the bast fibers from each other in a shorter time while restricting generation of the bad odor and a deterioration in the activity of the microorganisms.

In this way, in the defibration device 31, as in the above-described defibration device 11, it is possible to defibrate many bast fibers with a smaller amount of water. Further, the burden on the environment at the time of disposal is also mitigated. Further, in the defibration device 31, in particular, the separation of the exodermis, the product resulting from decomposition of the gum or other such substances is promoted due to the movement of the bast by the centrifugal force. Therefore, the amount of water required for washing the bast can also be reduced.

The defibration device of the present invention is not limited to the above-described embodiment and may have various constructions. For example, in a form that includes the circulation flow passage, it is possible to provide a plurality of processing vessels. Further, in a construction that uses the container 35, it is possible to additionally provide an aerating means. In this case, the container 35 may be completely immersed in the defibration liquid. Further, the container 35 may preferably be a type having a horizontal rotation shaft from the viewpoint of removal of the decomposition product or the like by the centrifugal force. However, the container is not limited to this type. That is, the container may be constructed so as to have a rotation shaft extending in the vertical direction or a rotation shaft extending obliquely. Further, the container 35 is not limited to the form in which the rotation axis is positioned at its center. Therefore, the container 35 may have a construction in which the rotation shaft is positioned outside the same.

### EXAMPLES

Kenaf was separated into a core and a bast, and the bast was pressed by a five-stage roller press in which distances of rollers facing each other were set to 1.5 mm, 1.2 mm, 0.8 mm, 0.5 mm and 0.2 mm. The bast was conveyed from a side where the clearance is larger, to a side where the clearance is smaller. After that, the bast was directly put in the processing vessel 12 shown in FIGS. 7 and 8. The letting is completed after it was checked as to whether the exodermis can be easily stripped by simply rubbing by hand and whether the fibers can be separated and such condition can be maintained after drying. Next, the fibers were washed manually, and were air-dried for three days. The bast fibers thus obtained were named Specimen G.

Further, the bast pressed in the same manner as described above was put in bags that are formed of the net. The bags were closed, and were put in the drum type container shown in FIGS. 9 and 10. This container was put in the microorganisms containing aqueous solution having a temperature of 36° C., and was rotated at a speed of 12 rpm. At this time, a ratio by weight of bast:water was 1:25. As in the above-described case, the letting is completed after the defibration was confirmed, and the bast was drawn and was washed by blowing water under a water pressure of 7.5 MPa by the high pressure washing machine (K370 Plus manufactured by Karcher Japan). The bast was air-dried for three days. The bast fibers thus obtained were named Specimen I. Further, the bast fibers were obtained in the same manner except that the bast was cut in a length of approximately 10 cm after pressing and was put in the bags. These bast fibers were named Specimen J.

As a control, the bast separated from the core was subjected to the same letting and manual washing as specimen G without pressing. Thereafter, the bast was air-dried for three days. The bast fibers thus obtained were named Specimen F. Further, the bast separated from the core was put in the same container as used in Specimen I without pressing, and was subjected to the similar letting and manual washing. Thereafter, the bast was air-dried for three days. The bast fibers thus obtained were named Specimen H.

FIG. 13 shows the letting periods (numbers of days) required for Specimens F to J, and their fiber strength (N). In the measurement of the fiber strength, the fibers of the specimens were cut in a length of 70 mm and were bundled by every 0.1 g thereof. Each of the bundles was bound by thread at 10 mm from both ends thereof and bonded, to thereby prepare samples. Each of these samples was pulled by an autograph that is provided with a load cell of 10 kN while gradually increasing the applied load. The load immediately before breakage was read as a maximum load.

As shown in FIG. 13, with regard to Specimens G and F and Specimens H and I that were respectively prepared in the same conditions except that pressing was performed or not, comparison was made. The comparison showed that, due to the pressing, a defibration period can be reduced by two or three days. Further, it became clear that the fiber strength is not scarcely reduced even if the pressing is performed. Further, upon comparing Specimen I that was subjected to the letting using the defibration device having the rotating container with Specimen G that was not subjected to such letting, the result showed that the defibration period can be reduced by half or less. Further, in Specimen I, the defibration period was three days, whereas, in Specimen H that was subjected to letting by the rotating container without pressing, the defibration period was five days. Thus, it has become apparent that this substantial reduction in the period can be achieved by combining pressing and letting in the rotating container. Further, upon comparing Specimen J in which the bast was cut prior to letting with the Specimen I in which the bast was not cut, the result showed that the cutting may reduce the defibration period by 1.5 days, that is, the fibers in the cut bast can be defibrated in approximately half period as compared with the case in which the bast was not cut. The fiber strength of Specimens F to. J were all approximately 200N. This result showed that there is no fear that the fibers are weakened by letting utilizing the rotating container, cutting of the bast prior to letting as well as high pressure washing.

Further, with regard to Specimens F and G that were subjected to the same processing except for pressing and Specimens I and J that were prepared by subjecting to the high pressure washing after letting in the rotating container, their yields were examined. The yields were measured in the same way as in the case of the bast fibers A and B described above.

The result showed that the yield of the bast fibers that were separated without pressing was 80.3%, whereas the yield of the bast fibers that were separated after pressing was 95.6%. This showed that pressing may contribute to provide the bast fibers of high yield, i.e., of high quality in a short time. Further, the yield of the bast fibers that were manually washed was 85.4%, whereas the yield of the bast fibers that were washed by the high pressure washing was 94.8%. This showed that the high pressure washing may provide the bast fibers that can be applied to a wide variety of uses.

1. A method for separating bast fibers existing in a bast of a bast plant, comprising a first step for separating the bast plant into the base and a core, a second step for pressing the bast separated from the ore, and a third step for immersing the pressed bast in an aqueous solution in order to decompose a gum existing in the bast and bonding the bast fibers to each other.

2. A method for separating the bast fibers as defined in claim 1, wherein in the second step the bast is pressed in a thickness direction of the bast fibers.

3. A method for separating the bast fibers as defined in claim 1, wherein in the second step the pressing is done by passing the bast between rollers or between a roller and a flat die.

4. A method for separating the bast fibers as defined in claim 3, wherein a surface of the roller or the flat die is formed with convex-concave portions in order to flaw a surface of the bast in the roller pressing step.

5. A method for separating the bast fibers as defined in claim 3, wherein the pressing step includes a plurality of rollers that are disposed successively in multiple stages along a direction that said bast is conveyed, and a plurality of rollers or flat dies that are disposed in multiple stages so as to respectively face said respective rollers, in order to roller press said bast by conveying said bast between said respective rollers and the rollers or flat dies, and that distances between respective surfaces of said rollers facing each other or distances between surfaces of the rollers and surfaces of the flat dies reduce from an inlet side toward an outlet side along the conveying direction.

6. A method for separating the bast fibers as defined in claim 1, further comprising a fourth step for washing the bast by spraying a aqueous solution against the bast at a pressure of MPa or more after the third step.

7. A method for separating the bast fibers as defined in claim 1, wherein in said third step, the bast is immersed in an aqueous solution containing microorganisms that can decompose the gum, the aqueous solution is circulated so as to flow in the bast portion and is aerated, and a solid substance is collected at a position spaced apart from the bast.

8. A method for separating the bast fibers as defined in claim 1, wherein in said third step, the bast is put in a container formed from a perforated member, and the container is immersed in an aqueous solution containing microorganisms that can decompose the gum in a manner that a part of the container is exposed above a surface of the aqueous solution and is rotated therein.

9. A method for separating the bast fibers as defined in claim 1, wherein the bast is cut in a longitudinal direction prior to the third step.
